(19) United States
(12) Patent Application Publication
(10) Pub. No.: US 2023/0058766 A1
(43) Pub. Date: Feb. 23, 2023

(54) Ultrasonic Humidifier

(71) Applicant: Zhibing Zhang, Dongguan City (CN)

(72) Inventor: Zhibing Zhang, Dongguan City (CN)

(73) Assignee: Chuangkexingqiu (Dongguan) Industrial Co., Ltd., Guangdong Province (CN)

(21) Appl. No.: 17/409,538

(22) Filed: Aug. 23, 2021

(51) Int. Cl. F24F 6/12; F24F 13/20

(52) U.S. Cl. CPC F24F 6/12; F24F 13/20; F24F 2006/008

(57) ABSTRACT

An ultrasonic humidifier may include a water tank, an atomizer arranged in the water tank, an upper cover detachably connected with the water tank and an artificial flower, wherein the upper cover is provided with a mist outlet pipeline, and a branch of the artificial flower is inserted from the mist outlet pipeline; and a user can change different varieties and styles of artificial flowers according to current mood. Different colors and styles of artificial flowers have different impacts on visual sense every time, which is not easy to generate visual fatigue. Moreover, mist is directly sprayed from the branch of the artificial flower, and the artificial flower becomes beautiful and elegant visually. When aromatic oil matched with the artificial flower is added into water, smell sense and visual sense of the user are capable of being perfectly unified.

### FIELD OF THE INVENTION

The Invention relates to the field of humidifiers, and more particularly, to an ultrasonic humidifier.

### BACKGROUND OF THE INVENTION

An ultrasonic humidifier is a small electrical appliance commonly used in daily life. The humidifier can increase a humidity in air and may also be used as an aroma diffuser, and aromatic odor is emitted from sprayed mist by only adding aromatic oil into water in the humidifier, which is very popular with consumers.

The humidifiers on the market are monotonous in appearance currently, which makes the consumers prone to visual fatigue as time passes.

### SUMMARY OF THE INVENTION

Aiming at the problems in the prior art, the Invention puts forward a new technical solution and adaptively improves an ultrasonic structure, so as to provide an ultrasonic humidifier which is capable of creating a strong visual effect and is more interesting.

The specific solution put forward by the Invention is as follows.

An ultrasonic humidifier comprises a water tank, an atomizer arranged in the water tank, an upper cover detachably connected with the water tank and an artificial flower, wherein the upper cover is provided with a mist outlet pipeline, and a branch of the artificial flower is inserted from the mist outlet pipeline.

Further, an upper end opening of the mist outlet pipeline is provided with a water guide inclined plane.

Further, since a diameter of the artificial flower is different from that of various branches, the smaller the diameter of the branch is, the larger the movable range is, and the branch is ideally a straight line with a diameter of zero herein; a diameter of a movable range of the branch of the artificial flower on a bottom surface of the water tank is D; an inner diameter of the mist outlet pipeline is defined as a; a length of the mist outlet pipeline is b; a height between a lower end of the mist outlet pipeline and the bottom surface of the water tank is c; and

$$D = \frac{2 a}{b} ( \frac{b}{2} + c ) ;$$

and the atomizer is arranged on a periphery of the diameter D.

Further, since the branch may bend somewhat in an implementation state, it is necessary to reserve a margin that the branch bends beyond the range D; and a minimum distance between an edge of the atomizer and an edge of the diameter D is not less than 5 mm.

Further, a blocking wall is arranged at a position on a bottom portion of the water tank close to the atomizer; and the blocking wall is formed by a baffle, an energy concentrating device or a guide baffle.

Further, a lower end face of the mist outlet pipeline is provided with a bottom plate having a water leakage hole, and a bottom portion of the artificial flower abuts against the bottom plate.

Further, a stopper is arranged below the mist outlet pipeline, the stopper covers a lower end of the mist outlet pipeline the artificial flower is inserted into the mist outlet pipeline and a bottom portion of the artificial flower abuts against the stopper.

Further, a lower end of the mist outlet pipeline is provided with a guide inclined plane for preventing a knot of the branch of the artificial flower from being caught when the artificial flower is taken out.

Further, the artificial flower is also capable of being a real flower, twig or branch.

Further a bottom portion of the branch of the artificial flower is sheathed with a silicone sleeve which takes a protective effect.

The beneficial effects achieved by the technical solution are as follows.

1. Since the artificial flower is directly inserted from the mist outlet pipeline, the Invention is simple in technology and model. A user may change different varieties and styles of artificial flowers according to current mood. Different colors and styles of artificial flowers have different impacts on vision every time, which is not easy to generate visual fatigue. Moreover, mist is directly sprayed from the branch of the artificial flower, and the artificial flower becomes beautiful and elegant visually. When aromatic oil matched with the artificial flower is added into water, smell sense and visual sense of the user are capable of being perfectly unified, thus being more interesting.

2. If (when) the mist impacts the branch of the artificial flower outside a mist outlet for a long time, small water drops condensed may appear on the branch of the artificial flower, and slowly accumulate into large water drops to flow downwardly, when flowing through the mist outlet pipeline, the water drops are guided into the mist outlet pipeline by the water guide inclined plane, and finally flow into the water tank, which will not cause a situation that the water drops flow outside the water tank.

3. Since the lower end of the mist outlet pipeline is provided with the guide inclined plane, when the user takes out (draws out) the artificial flower, the lower end of the mist outlet pipeline is prevented from catching the knot on the branch of the artificial flower, so that the artificial flower may be taken out more smoothly, and the user has better experience (feeling).

4. Since the lower end of the branch is provided with the silicone sleeve, a noise of collision with the bottom portion of the water tank when the branch is inserted is reduced, and meanwhile, the end face of the branch is prevented from scratching and polluting the bottom portion of the water tank (the branches of some artificial flowers are internally provided with an iron wire).

### BRIEF DESCRIPTION OF THE DRAWINGS

FIG. 1 is a schematic diagram of a humidifier of Embodiment 1.

FIG. 2 is a schematic diagram of calculation of a movable range D at a bottom portion of a branch of an artificial flower.

FIG. 3 is a schematic diagram of a blocking wall in a case of being a baffle in Embodiment 2.

FIG. 4 is an enlarged view of a part A in FIG. 3.

FIG. 5 is a schematic diagram of a blocking wall in a case of being an energy concentrating device in Embodiment 2.

FIG. 6 is a schematic diagram of a blocking wall in a case of being a baffle wall in Embodiment 2.

FIG. 7 is a schematic diagram of Embodiment 3.

FIG. 8 is a schematic diagram of Embodiment 4.

Wherein: 10—water tank, 20—atomizer, 30—upper cover, 31—mist outlet pipeline, 32—bottom plate, 33—stopper, 34—guide inclined plane, 40—artificial flower, 41—silicone sleeve, 51—baffle, 52—energy concentrating device, 53—guide baffle, and 311—water guide inclined plane.

### DETAILED DESCRIPTION OF THE INVENTION

The principle and feature of the Invention are described hereinafter with reference to the accompanying drawings, and the examples are only used to explain the Invention, and are not intended to limit the scope of the Invention.

### Embodiment 1

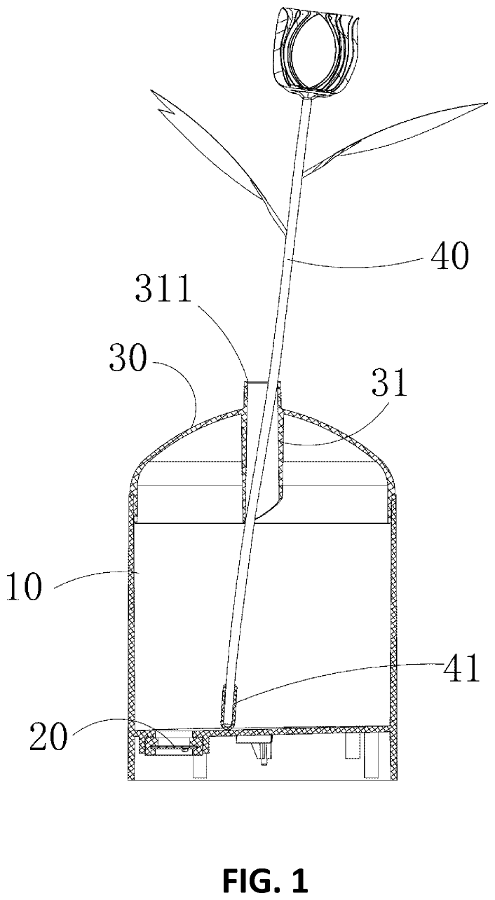

With reference to FIG. 1, the solution provides an ultrasonic humidifier, comprising a water tank 10, an atomizer 20 arranged in the water tank 10, an upper cover 30 detachably connected with the water tank and an artificial flower 40. The upper cover 30 is provided with a mist outlet pipeline 31, and a branch of the artificial flower 40 is inserted from the mist outlet pipeline 31.

The artificial flower which is convenient to replace is inserted into the mist outlet pipeline 31, so that the whole humidifier is simple in technology and model. A user may change different varieties and styles of artificial flowers 40 according to current mood. Different colors and styles of artificial flowers 40 have different impacts on visual sense every time, which is not easy to generate visual fatigue.

In order to prevent a situation that small water drops appear on the branch of the artificial flower in a mist spraying state, and gradually accumulate into large water drops to flow downwardly, and the water drops flow outside the water tank, an upper end opening of the mist outlet pipeline is provided with a water guide inclined plane 311. Through the water guide inclined plane 311 herein, the water drops condensed flow downwardly, and when flowing through the mist outlet pipeline 31, the water drops are guided into the mist outlet pipeline 31 by the water guide inclined plane 311, and finally flow into the water tank 10.

By adopting the above arrangement, when in use, mist is directly sprayed upwardly from the branch of the artificial flower 40, and the artificial flower 40 becomes beautiful and elegant visually. When aromatic oil matched with the artificial flower 40 is added into water, smell sense and visual sense of the user are capable of being perfectly unified, thus being more interesting.

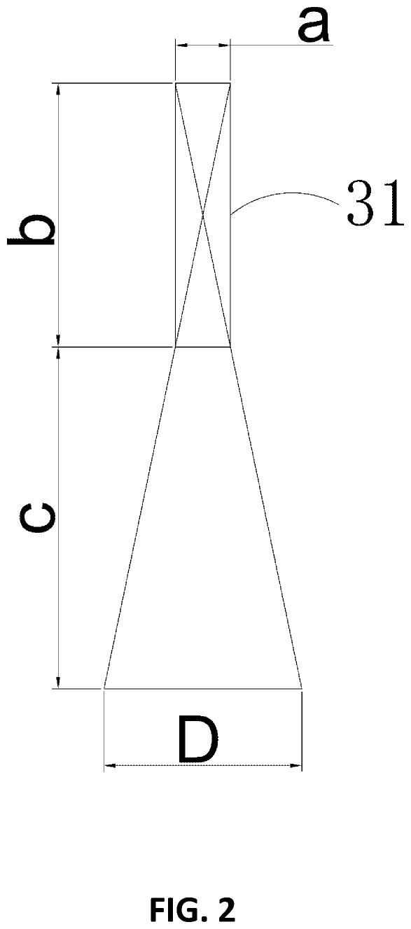

With reference to FIG. 2, in order to prevent the branch of the artificial flower 40 inserted into the bottom portion of the water tank 10 from being inserted into the atomizer 20 by mistake, a structure of the humidifier is further designed and limited in the solution. Since a diameter of the artificial flower is different from that of various branches, the smaller the diameter of the branch is, the larger the movable range is, and the branch is ideally a straight line with a diameter of zero herein. A diameter of a movable range of the branch of the artificial flower 40 on a bottom surface of the water tank 10 is defined as D; an inner diameter of the mist outlet pipeline 31 is defined as a; a length of the mist outlet pipeline 31 is b; a height between a lower end of the mist outlet pipeline 31 and the bottom surface of the water tank 10 is c.

Thus, it can be concluded that the movable range of the branch at the bottom portion of the artificial flower 40 on the bottom surface of the water tank 10 is the diameter D, wherein

$$D = \frac{2 a}{b} ( \frac{b}{2} + c ) ;$$

and the atomizer 20 is arranged on a periphery of the diameter D. Through the above arrangement, the branch of the artificial flower 40 will not be inserted into the atomizer 20.

Optionally, since the branch may bend somewhat in an implementation state, it is necessary to reserve a margin that the branch bends beyond the range D; and a minimum distance between an edge of the atomizer 20 and an edge of the diameter D is not less than 5 mm.

### Embodiment 2

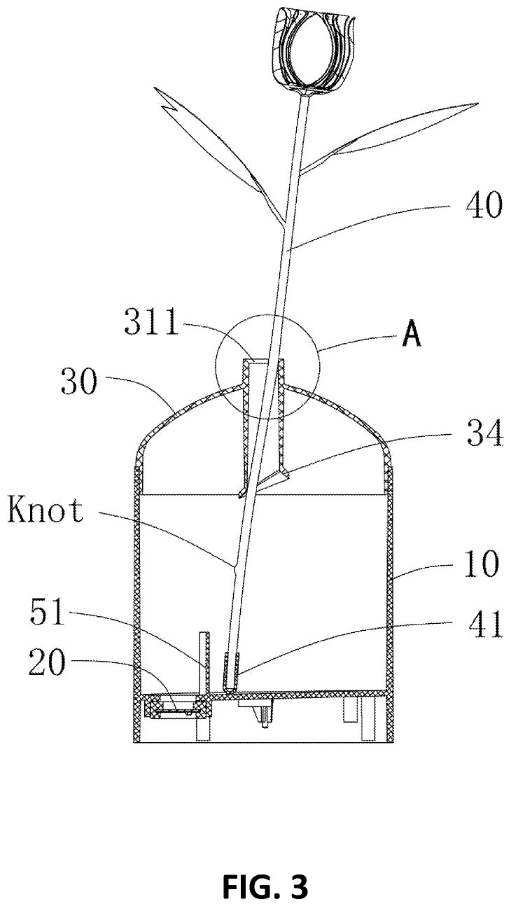

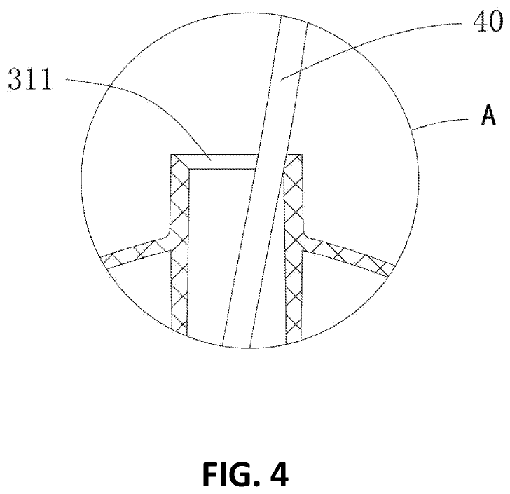

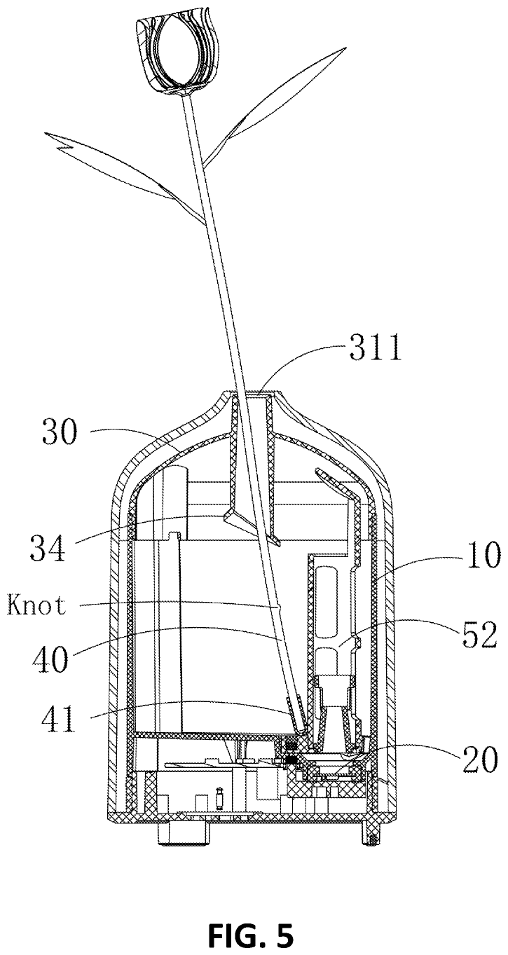

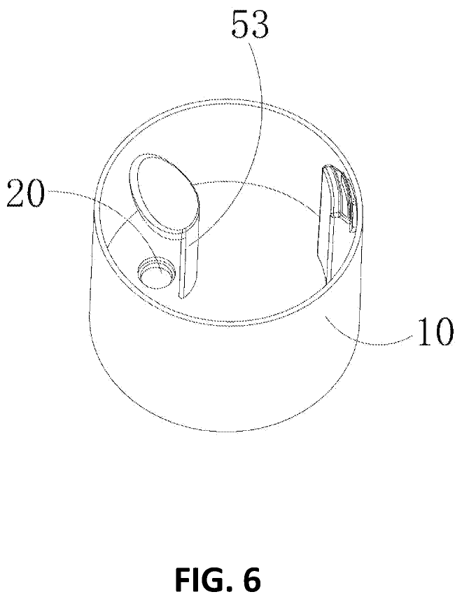

With reference to FIG. 3 to FIG. 6, the branch inserted into the water tank 10 may also be implemented by a blocking wall, which means that the blocking wall is arranged in a direction from a center of the atomizer 20 to a center of the diameter D, and a bottom portion of the branch may be blocked outside the atomizer 20 by the blocking wall. A structure of the blocking wall herein is selected according to a structure of the atomizer. For example, the blocking wall may be an ordinary baffle 51, an energy concentrating device 52 arranged in the water tank 10, or a guide baffle 53. Therefore, a specific form of the blocking wall is not limited, and the blocking wall may be of any structure capable of blocking the branch at the bottom portion of the water tank 10, which should fall within the scope of protection.

### Embodiment 3

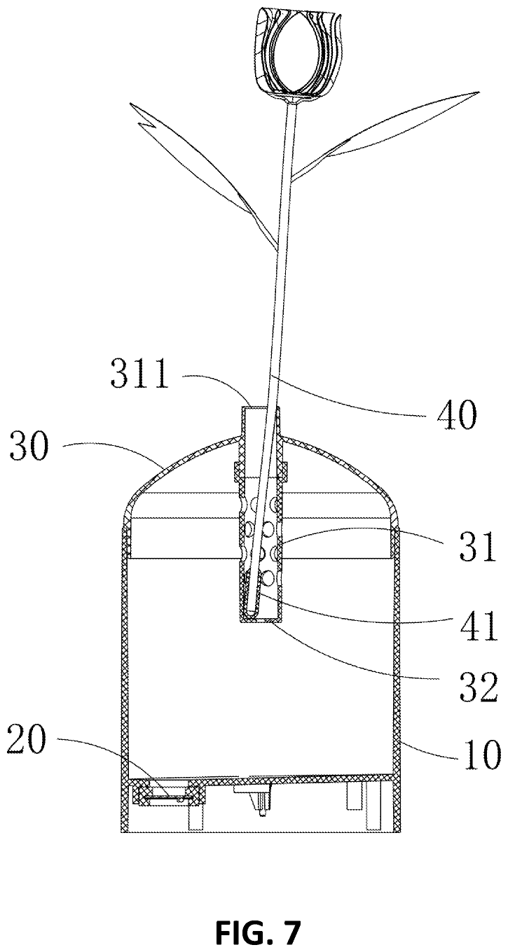

With reference to FIG. 7, the branch of the artificial flower 40 is not inserted into the bottom portion of the water tank 10, which means that a lower end face of the mist outlet pipeline 31 is provided with a bottom plate 32 having a water leakage hole, and a bottom portion of the artificial flower 40 abuts against the bottom plate 32.

### Embodiment 4

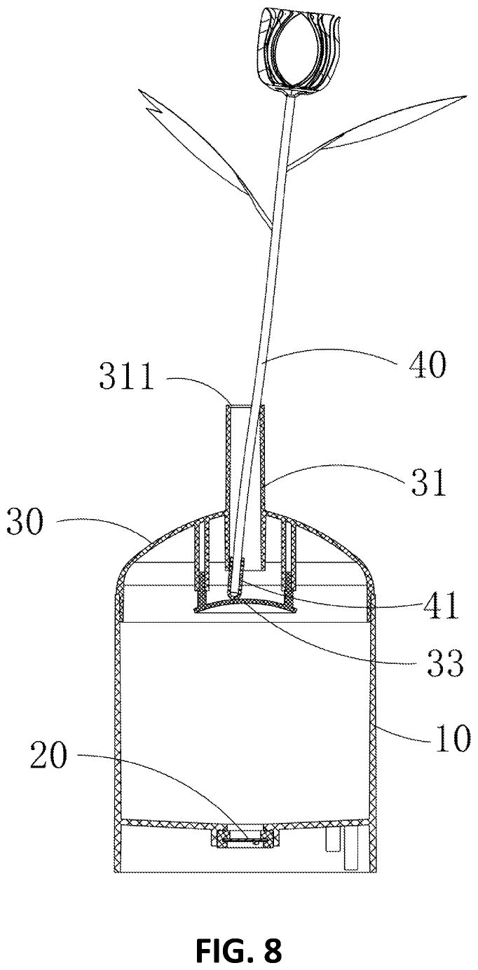

With reference to FIG. 8, the branch of the artificial flower 40 is not inserted into the bottom portion of the water tank 10, a stopper 33 is arranged below the mist outlet pipeline 31, the stopper 33 covers a lower end of the mist outlet pipeline 31, and the artificial flower 40 is inserted into the mist outlet pipeline 31 and a bottom portion of the artificial flower 40 abuts against the stopper 33.

In specific implementation of the above embodiments, when the user takes out (draws out) the artificial flower 40, the lower end of the mist outlet pipeline 31 may catch the knot on the branch of the artificial flower 40. Therefore, in order to prevent this situation, a lower end of the mist outlet pipeline 31 is provided with a guide inclined plane 34, so that the artificial flower may be taken out more smoothly by using the guide inclined plane 34, and the user has better experience (feeling).

In the solution, the mentioned artificial flower 40 is also capable of being a real flower, twig or branch.

In the solution, a bottom portion of the branch of the artificial flower 40 is sheathed with a silicone sleeve 41 which takes a protective effect. Since the lower end of the branch is provided with the silicone sleeve 41, a noise of collision with the bottom portion of the water tank 10 when the branch is inserted is reduced, and meanwhile, the end face of the branch is prevented from scratching and polluting the bottom portion of the water tank 10 (the branches of some artificial flowers are internally provided with an iron wire).

The technical effects achieved by the technical solution are as follows.

Since the artificial flower is directly inserted from the mist outlet pipeline, the Invention is simple in technology and model. A user may change different varieties and styles of artificial flowers according to current mood. Different colors and styles of artificial flowers have different impacts on visual sense every time, which is not easy to generate visual fatigue. Moreover, mist is directly sprayed from the branch of the artificial flower, and the artificial flower becomes beautiful and elegant visually. When aromatic oil matched with the artificial flower is added into water, smell sense and visual sense of the user are capable of being perfectly unified, thus being more interesting.

If (when) the mist impacts the branch of the artificial flower outside a mist outlet for a long time, small water drops may be condensed on the branch of the artificial flower, and slowly accumulate into large water drops to flow downwardly, when flowing through the mist outlet pipeline, the water drops are guided into the mist outlet pipeline by the water guide inclined plane, and finally flow into the water tank, which will not cause a situation that the water drops flow outside the water tank.

Since a lower surface of the mist outlet pipeline is provided with the guide inclined plane, when the user takes out (draws out) the artificial flower, the lower end of the mist outlet pipeline is prevented from catching the knot on the branch of the artificial flower, so that the artificial flower may be taken out more smoothly, and the user has better experience (feeling).

Since the lower end of the branch is provided with the silicone sleeve, a noise of collision with the bottom portion of the water tank when the branch is inserted is reduced, and meanwhile, the end face of the branch is prevented from scratching and polluting the bottom portion of the water tank (the branches of some artificial flowers are internally provided with an iron wire).

Those described above are merely preferred embodiments of the Invention, but are not intended to limit the Invention. Any modifications, equivalent substitutions and improvements made in the spirit and principle of the Invention shall all fall within the scope of protection of the Invention.

What is claimed is:

1. An ultrasonic humidifier, comprising a water tank, an atomizer arranged in the water tank, an upper cover detachably connected with the water tank and an artificial flower, wherein the upper cover is provided with a mist outlet pipeline, and a branch of the artificial flower is inserted from the mist outlet pipeline.

2. The ultrasonic humidifier according to claim 1, wherein an upper end opening of the mist outlet pipeline is provided with a water guide inclined plane.

3. The ultrasonic humidifier according to claim 2, wherein a diameter of a movable range of the branch of the artificial flower in the water tank is D; an inner diameter of the mist outlet pipeline is defined as a; a length of the mist outlet pipeline is b; a height between a lower end of the mist outlet pipeline and a bottom surface of the water tank is c; and
$$D = \frac{2 a}{b} ( \frac{b}{2} + c ) ;$$
and the atomizer is arranged on a periphery of the diameter D.

4. The ultrasonic humidifier according to claim 3, wherein a minimum distance between an edge of the atomizer and an edge of the diameter D is not less than 5 mm.

5. The ultrasonic humidifier according to claim 2, wherein a blocking wall is arranged at a position on a bottom portion of the water tank close to the atomizer; and the blocking wall is formed by a baffle, an energy concentrating device or a guide baffle.

6. The ultrasonic humidifier according to claim 2, wherein a lower end face of the mist outlet pipeline is provided with a bottom plate having a water leakage hole, and a bottom portion of the artificial flower abuts against the bottom plate.

7. The ultrasonic humidifier according to claim 2, wherein a stopper is arranged below the mist outlet pipeline, the stopper covers a lower end of the mist outlet pipeline, and the artificial flower is inserted into the mist outlet pipeline and a bottom portion of the artificial flower abuts against the stopper.

8. The ultrasonic humidifier according to claim 2, wherein a lower end of the mist outlet pipeline is provided with a guide inclined plane for preventing a knot of the branch of the artificial flower from being caught when the artificial flower is taken out.

9. The ultrasonic humidifier according to claim 1, wherein the artificial flower is also capable of being a real flower, twig or branch.

10. The ultrasonic humidifier according to claim 1, wherein a bottom portion of the branch of the artificial flower is sheathed with a silicone sleeve which takes a protective effect.
